(19) United States
(12) Patent Application Publication
(10) Pub. No.: US 2009/0070134 A1
(43) Pub. Date: Mar. 12, 2009

(54) TRACKING COMMUNICABLE PATHOGENS

(75) Inventor: Mark E. Rodgers, Jackson, MS (US)

Correspondence Address: Workman Nydegger;1000 Eagle Gate Tower, 60 East South Temple, Salt Lake City, UT, 84111, US

(73) Assignee: Valence Broadband, Inc., Ridgeland, MS (US)

(21) Appl. No.: 11/851,151

(22) Filed: Sep. 6, 2007

(51) Int. Cl. G06Q 50/00

(52) U.S. Cl. 705/2

(57) ABSTRACT

Methods, systems, computer program products, and data structures are used for tracking communicable pathogens in a healthcare facility. An individual is digitally tagged as been at risk for spreading communicable pathogens upon coming into contact with another individually that is digitally tagged as been at risk for spreading communicable pathogens. Digitally tagged individuals can be patients that are diagnosed with a communicable disease, individuals that come into contact with patients diagnosed with a communicable disease, and individuals that come into contact with other individuals (e.g., that through a chain of one or more other contacts) have been in contact with patients diagnosed with a communicable disease. Staff members and visitors digitally tagged through contact can perform appropriate hygiene procedures to remove their digitally tagged status. A system sensor can be used to track individual contacts and activation of hygiene equipment.

### CROSS-REFERENCE TO RELATED APPLICATION

N/A

### BACKGROUND OF THE INVENTION

1. Field of the Invention

The invention is in the field of patient monitoring systems and methods for ensuring compliance with healthcare instructions. The invention more particularly relates to dispensing medication and verifying proper use of medication.

2. Relevant Technology

Healthcare facilities provide clinical and/or wellness health care for patients and/or residents (hereinafter collectively referred to as “patients”) at such facilities. Hospitals and medical clinics provide clinical health care. Assisted living and nursing homes focus primarily on wellness health care but may also provide at least some clinical health care. Most facilities provide at least some monitoring and supervision of patients to ensure they are receiving proper nutrition and medicines, are kept clean, are protected from physical injury, and are protected from contracting communicable pathogens from other patients.

Antibiotic resistant infections are one highly dangerous source of communicable pathogens within healthcare facilities. They are in fact so dangerous that tens of thousands of individuals die from antibiotic resistant infections each year. Thus, healthcare facilities typically take various measures, such as, for example, patient isolation and staff hygiene protocols, to limit the spread of communicable pathogens, including antibiotic resistant infections. These protocols do reduce the likelihood of spreading communicable pathogens within healthcare facilities to some extent. However, in practice, the protocols are not totally effective in containing communicable pathogens due at least in part to human error.

Some mechanisms include the use of ethanol vapor detectors that detect the ethanol vapor emitted from a healthcare facility employee's skin. Based upon detected vapor levels, the detector approximates when the healthcare facility employee's hands are disinfected or not-disinfected. The detector provides an indication to the healthcare facility employee when approximated status their hands changes (e.g., from disinfected to non-disinfected and vice versa).

For example, when emitted ethanol vapors are low the detector can switch from indicating a disinfected state to indicating a non-disinfected state. When hands are subsequently washed and emitted ethanol vapors increase, the detector can switch from indicating a non-disinfected state to indicating a disinfected state. However, the practicality of these mechanisms is limited due to the multiple sources of ethanol vapor, potential variable air currents, multiple disinfecting solutions (e.g., non-ethanol based solutions), and different types of surgical glove utilization that may be present in the a healthcare facility. Any of these can alter the detected ethanol emissions from the skin to cause the detector to inappropriately transition states.

Other mechanisms include the use of timers that time hand washing events. The timer provides feedback to a healthcare facility employee as they wash their hands. The timer can indicate when a time period spend washing hands is sufficient (e.g., the timer has counted down from 30 seconds to zero). The timer can communicate with a controller to maintain cumulative hand washing hygiene data. Thus, the mechanisms can be beneficial to assist those that do wash their hands that the period of time spent washing is sufficient. However, these other mechanisms do not track the need of a particular healthcare facility employee wash their hands.

Further, neither of these mechanisms tracks the locations of employees, assets, and patients relative to one another to detect potential communicable events. For example, after thoroughly washing their hands an employee may immediately come into the physical proximity of a patient that has an antibiotic resistant infection. Unfortunately, upon leaving the patients room, neither mechanism can indicate that it is critical for the employee to again wash their hands before coming into contact with other employees, assets, and patients.

In view of the foregoing, it would be an advancement in the art to provide methods and systems for tracking communicable pathogens to mitigate the potential for spreading communicable pathogens.

### SUMMARY OF THE INVENTION

The present invention relates to tracking communicable pathogens in a healthcare facility. Real time data regarding the locations, movements and/or behaviors of individuals within a healthcare facility, such as, for example, staff, patients, and visitors, is obtained from multiple sources and analyzed by a computer system (e.g., facility master). The computer system meaningfully interprets the data to update and track contacts between individuals through the use of individualized profiles. The computer system can determine when an individual comes in contact with another individual that is digitally tagged as being at risk for spreading a communicable pathogen. When contact occurs, the computer system can digitally tag the individual as being at risk based on contact with the other digitally tagged individual. When an individual is digital tagged as being at risk, the computer system may initiate an appropriate response to insure that sufficient hygiene procedures are performed to mitigate the risk. When the performance of sufficient hygiene (e.g., to at least mitigate the risk of spreading a communicable pathogen) is subsequently detected, the digitally tagged status of an individual can be removed.

Data regarding the location, movements and/or interactions of patients, staff, and visitors throughout or outside a facility can be continuously gathered using any detection means known in the art including, but not limited to, RFID devices, an RFID detection grid, GPS devices, ultrasound devices, ultrasound detection grid, cameras, motion detectors, light beam detectors, image analysis systems and the like. For example, various sensors can be used to detect when individuals come within a specified physical proximity of one another and when an individual has performed sufficient hygiene procedures.

The locations of individuals within a facility can be (potentially continuously) monitored to determine when individuals come in contact (e.g., within a specified physical proximity) of one another. Upon detecting contact, the computer system can refer to the profile for each individual. It may be that a profile for one individual indicates that the individual is digitally tagged with a status of being at risk for spreading a communicable pathogen. In response, the profile for each other individual in contact with the digitally tagged individual is refined to digitally tag each of the other individuals with a status of being at risk.

When an at risk status is propagated to new individuals, electronic messages, such as, for example, alerts or alarms, can be sent to appropriate facility personnel. In some embodiments, messages are sent directly to individuals that are digitally tagged alerting the individuals to perform appropriate hygiene procedures. When the computer system detects performance of appropriate hygiene procedures, the individual's profile can be further refined to remove the digital tag and thus also remove the at risk status.

By refining patient specific profiles based on gathered data, such as, for example, indications of when a communicable pathogen has potentially been transferred from one individual to another and when an individual has performed appropriate hygiene procedures, the inventive systems and methods are able to interpret behaviors, conditions and events in a highly individualized manner as among different individuals at a healthcare facility.

Thus, an individual profile can include data indicating if an individual is at risk for spreading a communicable pathogen, as well as other types of static and dynamic data relating to a plurality of specific care and wellness parameters. Profile data can be uploaded to networked or peripheral computers as needed to carry out monitoring the potential spread of communicable pathogens. An information feedback loop can be used to update each individual profile, which may occur automatically or manually, in order to create and maintain a current database of individual status, attributes and needs.

The ultimate purpose of the inventive methods and systems is to mitigate or eliminate potential outbreaks of communicable disease at a facility or among groups of individuals who may come into contact with each other.

These and other advantages and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts an example facility monitoring master system.

FIG. 2 depicts an example computer architecture that facilitates facility, patient, staff, and/or visiting monitoring within a healthcare facility.

FIGS. 3A-3D depict different portions of an example computer architecture that facilitates tracking communicable pathogen exposures within a healthcare facility.

FIG. 4 is a flow chart that illustrates an exemplary method for digitally tagging an individual as at risk for spreading a communicable pathogen.

FIG. 5 is a flow chart that illustrates an exemplary method for indicating that an individual is disinfected.

### DETAILED DESCRIPTION OF THE PREFERRED EMBODIMENTS

### I. Introduction

Embodiments of the present invention extend to methods, systems, computer program products, and data structures for tracking communicable pathogens within a healthcare facility.

Individual specific data, including communicable pathogen status and events that can change communicable pathogen status, can be tracked and maintained for each individual within healthcare facility (including staff, patients, and visitors) to create a database of generalized and personalized knowledge. Profile specific data can be used to monitor quality and performance at a facility and helps ensure that each patient at the facility receives a prescribed level of care. To be sure, there are general aspects and levels of patient care and wellness that may be substantially similar for some or all patients, including the need for adequate rests, nutrition, cleanliness, safety, privacy, some amount of staff-to-patient contact time, having sufficient staff present at the facility, freedom from inappropriate exposure to communicable pathogens, and the like. On the other hand, some or all patients may require specialized care (e.g., different types and dosages of medication) and have different criteria based on individual patient needs (e.g., based on age, physical capacity, mental capacity, and the like).

The quality and performance systems and methods of the invention monitor care and wellness for each individual within a healthcare facility by means of automated tracking of staff, patients, and visitors. The inventive methods and systems track individual locations, activities, condition, and regimen completion. Care and wellness are measured generally as well as in relation to individual patient profiles which are maintained and periodically refined for each patient. According to one embodiment, the methods and system initiate responses to pre-determined triggering events to prevent or mitigate patient harm or to remedy other deficiencies related to patient care. For example, potential exposure to communicable pathogens (e.g., bacteria, viruses, fungi) can be detected, exposed individuals can be contacted through electronic communication, and disinfecting hygiene can be implemented.

The methods and systems are implemented using a computer-controlled electronic monitoring system that receives and analyzes data generated by a network of electronic data generating devices. A profile maintenance and refinement sub-system and method is used to periodically update and refine staff, patient, visitor profiles, as well as track facility wide parameters, as data is received and analyzed for the facility as well as individual staff, patients, and visitors. The care and wellness of a patient, as well as the performance of staff, can be analyzed and improved through the use of individually refined profiles.

The term individual profile shall refer to stored data that is associated with a specific individual at a healthcare facility. Individual profiles typically include static data and dynamic data. Dynamic data refers to limits and alarms that are continuously or periodically updated or refined based on information learned about the individual. Dynamic data can be automatically updated in response to events or it may be manually updated by staff after an event. Different individual profiles can be used to maintain different types of data depending on the individual's relationship to a healthcare facility. For example, profiles can be used maintain different types of data for staff, patients, and visitors.

Thus, the term “patient profile” shall refer to stored data that is associated with a specific patient at a healthcare facility. The term “staff profile” shall refer to stored data that is associated with a specific caregiver, provider, or staff member at a healthcare facility. Thus, the term “visitor profile” shall refer to stored data that is associated with a specific visitor at a healthcare facility. Accordingly, an individual profile may be a patient profile, a staff profile, or a visitor profile, based on the relationship of an individual to a healthcare facility

The terms “care” and “wellness” shall be broadly understood to cover every aspect of a patient's life and well being that are relevant to care and treatment at a health facility. Care more particularly relates to treatments (e.g., prescribed medications), activities and regimens that are provided to the patient in order to ensure a prescribed or minimum level of general health and well-being. Wellness is a measure of the general health and well-being of the patient. Care and wellness affect the overall quality and performance of a healthcare facility.

The terms “continuous monitoring” and “continuous video data stream” include taking a series of images that may be spaced apart by any appropriate time interval so long as the time interval is sufficiently short that the system is not unduly hampered from initiating a response in time to prevent or mitigate a potentially dangerous event.

The terms “receiving” and “inputting” in the context of an individual profile broadly includes any action by which a complete or partial individual profile (whether be a patient profile, a staff profile, or a visitor profile), or any component thereof, is stored or entered into a computer system. This includes, but is not limited to, creating a profile and then storing or entering it into a computer, entering data which is used by the computer to generate a new profile, and/or storing or entering data used by a computer for updating a pre-existing profile already in the computer.

Those skilled in the art will appreciate that the invention may be practiced in network computing environments with many types of computer system and electronic device configurations, including, personal computers, desktop computers, laptop computers, hand-held devices, multi-processor systems, microprocessor-based or programmable consumer electronics, network PCs, minicomputers, mainframe computers, mobile telephones, PDAs, one-way and two-way pagers, Radio Frequency Identification (“RFID”) devices (e.g., bracelets, tags, etc.), ultrasound devices (e.g., bracelets, tags, etc.), global position (“GPS”) devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present invention may comprise or utilize a special purpose or general-purpose computer including computer hardware, as discussed in greater detail below. Embodiments within the scope of the present invention also include physical and other computer-readable media for carrying or having computer-executable instructions or data structures stored thereon. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, computer-readable media can comprise physical storage media or transmission media.

Physical storage media can include RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry or desired program code means in the form of computer-executable instructions or data structures and which can be accessed by a general purpose or special purpose computer. Combinations of the above should also be included within the scope of computer-readable media.

However, it should be understood, that upon reaching various computer system components program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

### II. Computer-Implemented Electronic Monitoring System and Method for Tracking Communicable Pathogens

A. Exemplary System Architecture

According to one currently preferred embodiment, the communicable pathogen tracking systems and methods of the invention are implemented by means of a computer system. The computer system may include one or more centralized computers, referred to as a “facility master”, and one or more localized computers, exemplified by one or more “in room controllers”. The various computers within the overall computer system divide up the task of receiving and analyzing data gathered from the overall monitoring system.

A facility master computer system can receive data regarding patients, staff, and visitors from a variety of data collection clients within and outside a facility. Data collection clients can include, for example, in room controller clients, room associated clients, care giver system clients, facility patient, staff, and visitor tracking and location clients, and external facility patient, staff and visitor tracking clients. The data gathered or generated by the data collection clients is sent to the facility master computer system by means of communication pathways (e.g., IEEE 802.xx wireless, RFID, ultrasound, GPS, etc.) for analysis, response, and report. In some cases, a localized computer, such as an in room controller client and/or, may perform its own analysis of gathered data in order to compartmentalize or bifurcate the tasks provided by the various computers of the computer system in order to more efficiently use the computer system resources and reduce bottle necks.

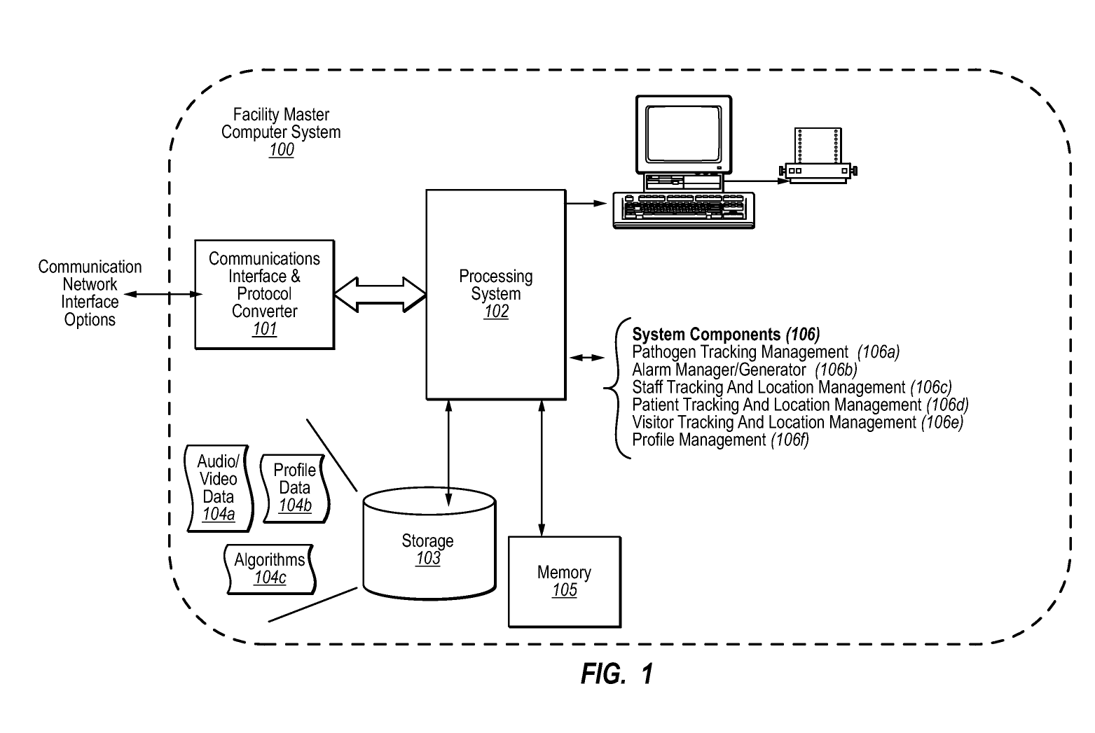

FIG. 1 schematically illustrates an exemplary facility master computer system 100 that can be used to control and implement communicable pathogen tracking systems and methods according to the invention. Communications interface and protocol converter 101 can receive communications in accordance with various protocols of and can convert the communication so as to be compatible with a processing system 102. Storage 103 can store data used and produced by the processing system 102, examples of which include archived audio/video data 104a (e.g., archived in response to detection of an actionable event), profile data 104b (e.g., patient, staff, and visitor data), and algorithms 104c used to process data and initiate appropriate responses and reports. Memory 105 can be used to buffer and quickly access short term data used or generated by the processing system 102.

The facility master computer system 100 includes exemplary system components 106, which are modules or applications that process data gathered by data collection and processing devices. Some of these modules or applications can also be run, at least in part, by local computers, such as in room controller clients (not shown). These modules can include pathogen tracking management 106a, alarm manager/generator 106b, staff tracking and location management 106c, patient tracking and location management 106d, visitor tracking and location management 106e, and profile management 106f.

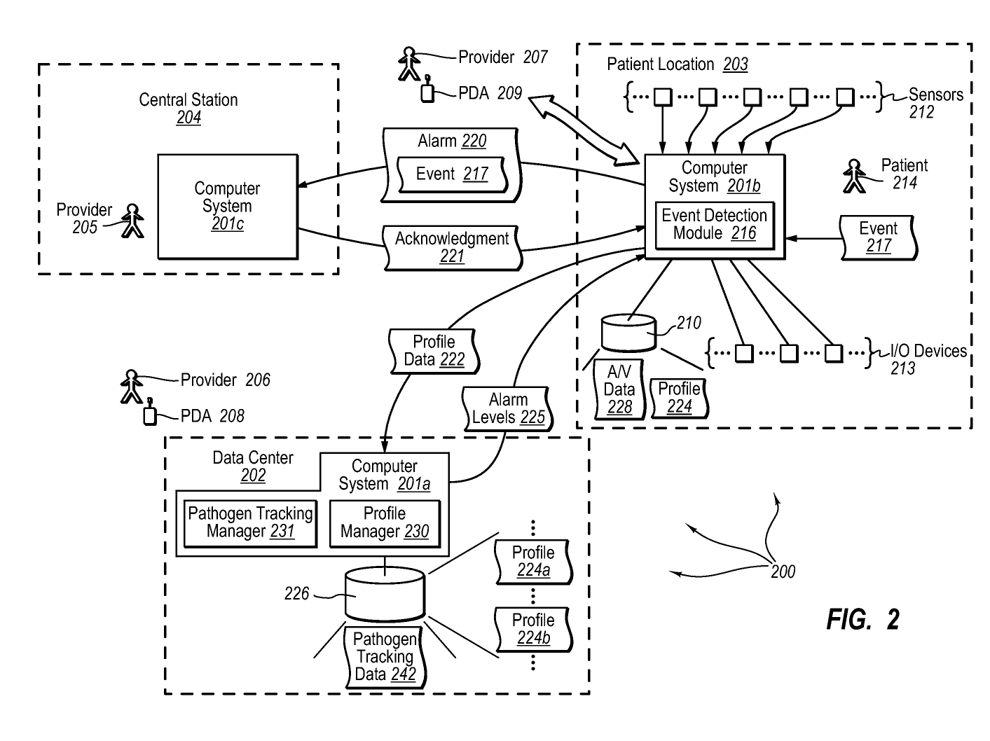

FIG. 2 illustrates an exemplary computer-implement monitoring system 200 that monitors patients, staff, and visitors, tracks communicable pathogens, and manages event responses at a healthcare facility. Monitoring system 200 includes a networked computer system 201, which is composed of a main computer system 201a (e.g., facility master) located in a data center 202, first peripheral computer system 201b (e.g. in room controller client) at patient location 203, and second peripheral computer system 201c at a central station (e.g., nurse's station). Each computer system 201a-c can be connected to a network, such as, for example, a Local Area Network (“LAN”), a Wide Area Network (“WAN”), or even the Internet. The various components can receive and send data to each other, as well as other components connected to the network. Networked computer systems constitute a “computer system” for purposes of this description.

Networks facilitating communication between computer systems and other electronic devices can utilize any of a wide range of (potentially interoperating) protocols including, but not limited to, the IEEE 802 suite of wireless protocols, Radio Frequency Identification (“RFID”) protocols, ultrasound protocols, infrared protocols, cellular protocols, one-way and two-way wireless paging protocols, Global Positioning System (“GPS”) protocols, wired and wireless broadband protocols, ultra-wideband “mesh” protocols, etc. Accordingly, computer systems and other devices can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), Simple Object Access Protocol (“SOAP”) etc.) over the network.

In some embodiments, a multi-platform, multi-network, multi-protocol, wireless and wired network architecture is utilized to monitor patient, staff, and asset locations, movements, and interactions within a facility. Computer systems and electronic devices may be configured to utilize protocols that are appropriate based on corresponding computer system and electronic device on functionality. For example, an electronic device that is to send small amounts of data a short distance within a patient's room can be configured to use Infrared protocols. On the other hand, a computer system configured to transmit and receive large database records can be configured to use an 802.11 protocol. Components within the architecture can be configured to convert between various protocols to facilitate compatible communication. Computer systems and electronic devices may be configured with multiple protocols and use different protocols to implement different functionality. For example, an in room controller or other computer system 201b at patient location 203 can receive patient data via infrared from a biometric monitor and then forward the patient data via fast Ethernet to computer system 201a at data center 202 for processing.

In some environments, ultrasound technologies, such as, for example, those developed by Sonitor Technologies, may be preferred for monitoring patient, staff, and visitor locations, movements, and interactions within a facility. Ultrasound waves can be blocked by normal walls, are less likely to reflect off of metallic objects, and are less likely to interfere with sensate instruments. For example, ultrasound waves can be confined to a room (e.g., a patient room) where they originate. When using ultrasound receivers and detectors, various Digital Signal Processing (DSP) algorithms can be used to convert ultrasound waves into meaningful digital data (e.g., for transport on a wired network). The DSP algorithms can be configured to ensure that ultrasound detectors interpret ultrasound waves without risk of interference from any environmental noise or other signals nor interference with sensitive instruments.

However, in other environments the increased range of RFID may be preferred for monitoring patient, staff, and visitor locations, movements, and interactions within a facility. For example, since RFID signals can pass through walls, RFID detection systems can be implemented with fewer detectors.

Computer system 201c can be physically located at a central station 204 of a healthcare facility, e.g., a nursing station. Provider 205 (a nurse or other healthcare worker) can be physically located near computer system 201 c such that provider 205 can access electronic communications (e.g., alarm 220, video feeds, A/V communications) presented at computer system 201c. Acknowledgment 221 can be sent to other computer systems 201a, 201b as appropriate to verify that alarm 220 was considered by provider 205. Other healthcare providers, such as providers 206 and 207, can be physically located in other parts of a healthcare facility. Healthcare providers can move between different locations (e.g., central station 204, patient rooms, hallways, outside the building, etc.). Accordingly, healthcare providers 206, 207 can also carry mobile computer systems (e.g., laptop computers or PDAs 208 and 209) and other types of mobile devices, (e.g., pagers, mobile phones, GPS devices, RFID devices, or ultrasound devices). As providers 206, 207 move about a healthcare facility they can still access electronic messages (e.g., alarms) and send messages.

Computer system 201b, storage device 210, sensors 212, and I/O devices 213 can be physically located at patient location 203, such as patient rooms, common areas, hallways, and other appropriate locations throughout or outside a healthcare facility. For example, patient location 203 can be a room of a patient 214. Sensors 212 can include various types of sensors, such as, for example, video cameras, still cameras, microphones, motion sensors, acoustic sensors, RFID detectors, ultrasound detectors, global positioning sensors (“GPS”), etc. Although depicted separately, I/O devices 213 can also be sensors. Sensors and I/O devices can also send data to any appropriate computer system for processing and event detection, including either or both of computer systems 201a and 201c.

Some sensors 212 can be stationary (e.g., mounted at patient location 203) such that the sensors sense patient, staff, or asset characteristics when within a specified vicinity of the sensor 212. Other sensors can be mobile and move with a patient, provider, or asset as they move about a healthcare facility. As a patient, provider, or asset moves about a healthcare facility, different combinations of stationary and mobile sensors can monitor the patient, provider, or asset at different locations and/or times.

Each of sensors 212 can provide input to computer system 201b. Event detection module 216 can monitor and process inputs from sensors 212 to detect if a combination of inputs indicates the occurrence of a potentially actionable event 217, such as, for example, exposure to and/or potentially spreading of communicable pathogens. Detecting the occurrence of event 217 can trigger the transfer of various electronic messages from computer system 201b to other networked computers of the monitoring system 200. For example, electronic messages (alarm messages 220 regarding event 217) can be transferred to computer system 201c and/or mobile devices to alert health care providers of an actionable event 217. Alternatively or in addition, electronic messages including profile data 222 (e.g., for a patient, staff member, or visitor) can be transferred to other computer systems, such as computer system 201 a, that process profile data 222 (e.g., for refining patient, staff member, or visitor profiles). Alarm levels 225 can be sent to computer system 201b for use in determining whether an event 217 is actionable.

One or more of sensors 212 can be used to detect patient, staff, and visitor conditions or performance, such as, for example, coming within specific physical proximity of an individual that has been digitally tagged as benign at risk for spreading a communicable pathogen, etc. Computer system 201b can buffer sensor input at storage device 210 for some amount of time before discarding the input (e.g., video data). In response to detecting the occurrence of an event 217, computer system 201b can locally archive sensor input or data from I/O devices 213 at storage device 210 (e.g., A/V data 228).

For example, a camera and/or other sensors can archive a staff member or visitor coming into physical contact a patient that has been diagnosed with a communicable pathogen. Alternately, a camera and/or other sensors can archive a staff member, visitor, or patient coming into physical contact an individual that is otherwise digitally tagged as being at risk for spreading a communicable pathogen. For example, a visitor may come within a specified physical proximity of a staff member that has not yet performed appropriate hygiene measures after patient contact.

Buffered and/or archived sensor input can provide the basis for profile data 222 that is transferred to other computer systems.

Event occurrences, such as, for example, contact with an individual having a communicable pathogen, can be detected in accordance with a profile associated with an individual. For example, profiles 224, either accessed directly from computer system 201a or stored locally in storage 210, can be used to analyze data from sensors 212. Alternatively, alarm levels 225 can be used independently of a profile 224 by local computer system 201b. Based on differing profiles 224 and/or alarm levels 225 for a plurality of patients, staff members, and/or visitors, a combination of inputs detected as the occurrence of an (actionable) event 217 for one individual is not necessarily detected as the occurrence of an (actionable) event 217 for another individual, and vice versa. For example, contact with a patient having a communicable pathogen can trigger an actionable event. On other hand, contact with a patient having some other ailment, such as, for example, a broken bone, may not necessarily trigger an actionable event. An actionable event can be detected when a specified alarm level for a given individual is satisfied.

Computer system 201 a and storage device 226 can be physically located at data center 202. Storage device 226 can store profiles (e.g., profiles 224a and 224b) for patients, staff, and visitors. Profile manager 230 can receive profile data 222 sent to computer system 201a (e.g., in response to a detected event) and refine a corresponding profile 224 in accordance with the profile data 222. Thus, as data related to patient 214 changes, the patient's profile 224 can be modified to indicate changed risks, limits and alarm levels for the patient 214. Risk profiles for a patient can be iteratively refined as profile data 222 for the patient 214 is received. For example, if patient 214 is diagnosed with a communicable disease infection, the patient's profile 224 can be updated to indicate the characteristics of the infection (e.g., time of diagnosis, cause of infection, type of infection, estimated duration of contagiousness, resistance to any medications, time treatment regimen was initiated, etc.). Algorithms for refining profiles can be recursed on a per iteration basis.

Patients, providers, and visitors may carry RFID transmitting devices, each having a unique signature such that an RFID transmitting device can be used to determine the location of a patient, provider, or visitor within a healthcare facility. RFID transmitting devices can be non-removable, such as a bracelet or an adhesively attached pad, or removable, such as an employee or visitor badge. Transmitted RFID signals can be detected by RFID receivers, which are examples of sensors that can be included in sensors 212.

Alternately, patients, providers, and visitors may carry ultrasound transmitting devices that can be used to determine patient, provider and visitor locations within a healthcare facility. Transmitted ultrasound waves can be detected by ultrasound receivers.

As depicted, computer system 201 a also includes pathogen tracking manager 231. Pathogen tracking manager 231 tracks exposures to communicable pathogens. Exposures can include exposure to a patient diagnosed with a communicable disease or expose to an individual that has not performed hygiene procedures. A need for hygiene procedures can arise after contact with a diagnosed patient or contact with another individual that has otherwise been exposed (e.g., through a chain of contacts). Pathogen tracking manager 231 can also track when an exposed individual has performed adequate hygiene procedures.

Pathogen tracking module 231 can maintain pathogen tracking data 242, such as, for example, pathogen, time of exposure, number of individuals exposed, number of individuals not yet disinfected, etc., for any active exposures within a facility. Other modules can refer to pathogen tracking manager 231 to obtain data related to communicable pathogen exposures.

When provider 207 enters patient location 203 (e.g., the patient's room), sensors 212 can detect that the provider 207 and patient 214 are commonly occupying patient location 203. Upon detecting entrance into patient location 203, computer system 201b can query computer system 201a for communicable pathogen data for each of provider 207 and patient 214. Profile manager 230 can refer to profiles 224 (e.g., 224a and 224b) for provider 207 and patient 214 respectively. Pathogen tracking manager 231 can analyze the profiles to determine if provider 207 and/or patient 215 is at risk for spreading a communicable pathogen. For example, pathogen tracking manager 231 can determine from the profiles if provider 207 and/or patient 214 has a communicable pathogen or did not disinfect after a prior exposure to a communicable pathogen.

When provider 207 and/or patient 214 is at risk for spreading a communicable pathogen, the other of provider 207 and/or patient 214 is thus also at risk for spreading the communicable pathogen. Thus, a provider can place a patient at risk and vice versa. For example, if patient 214 has a bacterial infection, provider 207's contact with patient 214 places them at risk for spreading the bacterial infection. Alternately, it may be that provider 207 was in recent contact with another patient having a bacterial infection and failed to perform appropriate disinfecting procedures (e.g., degloving and washing hands) prior to entering patient location 203. Thus, upon entering patient location 203, provider 207 places patient 214 at risk.

When an individual is placed at risk, profile data can be refined to indicate the risk. Computer system 201b can send the refined profile data to computer system 201a. Computer system 201b (or 201a) can digitally tag the profile to indicate that the individual is at risk for spreading a communicable pathogen. Thus, in response to an inference that a provider, patient, or visitor has been exposed to a communicable pathogen, computer system 201a can refer to an appropriate profile and indicate the exposure within the profile.

B. Event Response

Appropriate responses to an alert or alarm of an event can be provided through communication among and between computer systems. The difference between an alert and alarm is one of severity. If a trigger is minimally exceeded, an alert is activated. Typical alert responses include notification of event to the nursing station, establishment of A/V contact with patient, sounding of a tone, or verbally dispatching staff to investigate the situation. Significantly exceeding trigger value or ignored alerts will generate alarms, which typically activate an automatic PDA dispatching of staff, A/V contact and report generation.

Events can be human or computer generated events. For example, a patient attempting to exit a bed or attempting to enter a restricted area are human generated events. On the other hand, expiration of a timer can be a computer generated event. Both human and computer generated events can vary in severity, thus potentially causing alerts or alarms.

Detection a plurality of individuals within a specified physical distance of one another (e.g., a few feet) can also trigger actionable events. For example, when a staff member that has failed to perform hygiene contacts other individuals, appropriate staff members (including the staff member that did not perform hygiene) can be notified. Computer system 201b can send an alert to PDA 208, PDA 209 (or other appropriate computer systems) when there is some potential for spreading a communicable pathogen.

Contact can also trigger non-actionable events. Non-actionable events can cause data processing activities (e.g., checking values in or refining a profile) to occur without notifying a staff member. For example, when the performance of staff hygiene is detected, a digital tag indicating that a staff member is at risk for spreading a communicable pathogen can be removed from the staff members profile.

C. Measuring Care and Wellness

Patient care and wellness can be monitored in a variety of ways. According to one embodiment, appropriate care and wellness according to certain parameters can be determined by tracking communicable pathogens.

Generally, a computer system accesses stored patient profiles, which contain data that relate to one or more care or wellness parameters. The computer system identifies one or more care or wellness parameters for each of a plurality of patients based on profile data contained in a corresponding patient profile. Examples of care or wellness parameters can include parameters related to tracking exposures to communicable pathogens, diagnosis of having communicable infections, etc.

Many care and wellness parameters, such as, for example, those related exposures to communicable pathogens, involve interactions between a patient and a caregiver and/or a visitor. Thus, tracking the locations of patients, caregivers, and visitors relative to one another can be used to at least infer when exposure to communicable pathogens has occurred. For example, a patient who is detected near another digitally tagged individual is likely to be placed at risk for contracting a communicable pathogen.

By way of example, patients, staff, and visitors can be assigned and/or include an RFID (or ultrasound) device that can be tracked throughout a facility by means of an RFID (or ultrasound) detection system comprising a plurality of RFID (or ultrasound) detectors throughout the facility. The location of the RFID (or ultrasound) detectors and assignment and/or inclusion of RFID (or ultrasound) devices can be recorded and maintained in a computer system. As patients, staff, and visitors move throughout the facility and potentially commonly occupy locations within a facility, the RFID (or ultrasound) detectors notify the computer system of RFID (or ultrasound) devices that are currently being detected. Thus, the computer system can correlate the location of each RFID (or ultrasound) device, as well as the duration of each RFID (or ultrasound) device at a specific location, and determine (or at least infer) whether when potential exposures to communicable pathogens occur. When appropriate, a response can be initiated to prevent or mitigate harm in the case of an actual event (e.g., an exposure to a communicable pathogen), refine a patient profile (to remove a digitally tagged status in response to detecting performance of hygiene) and/or generating a care or wellness report.

### III. Computer-Implemented Electronic Communicable Pathogen Tracking

A. Exemplary System Architecture

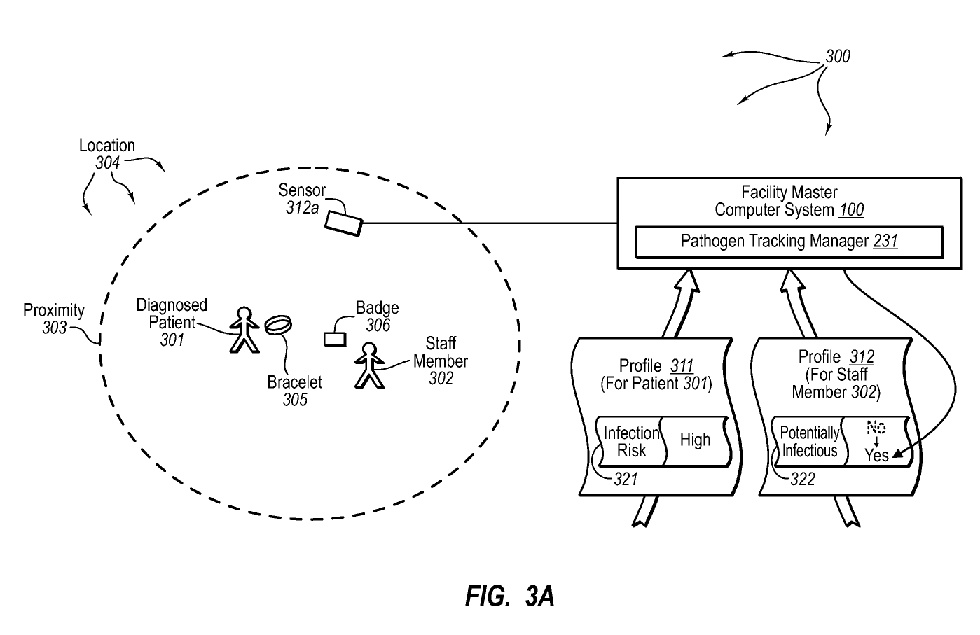

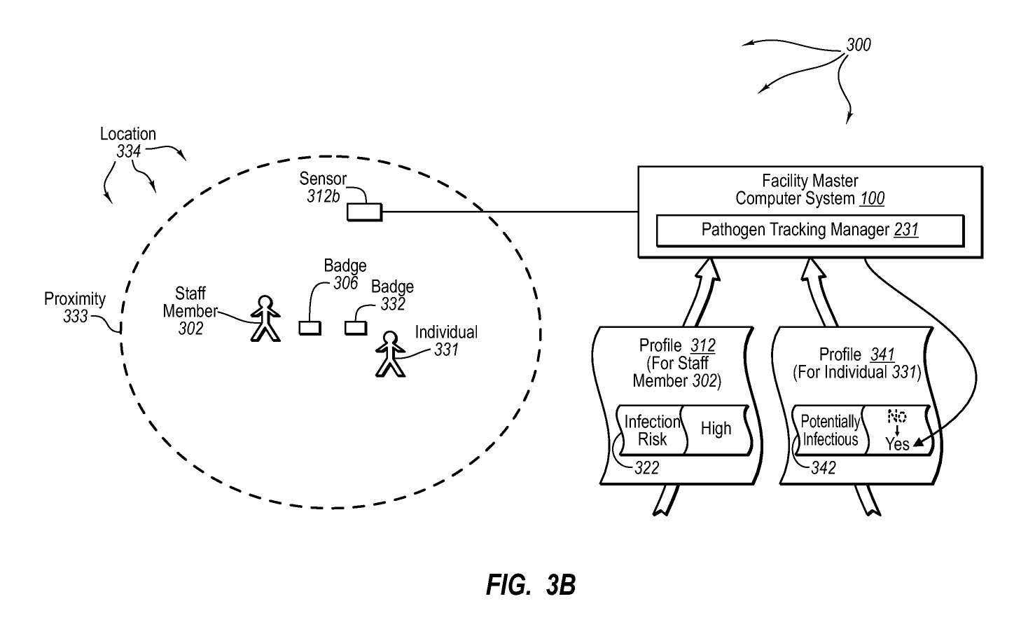

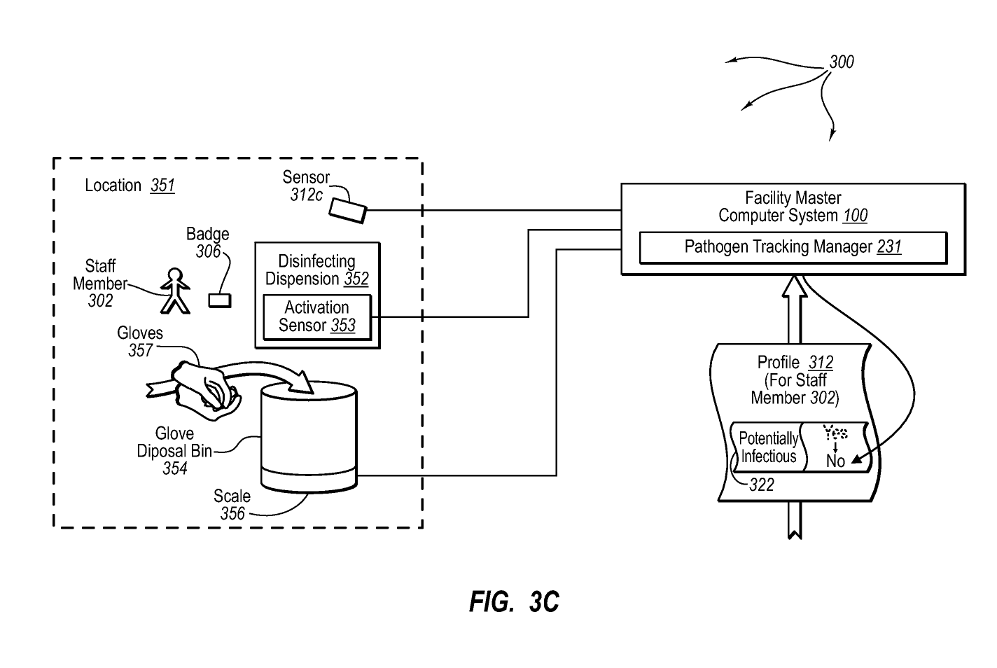

FIGS. 3A-3D depict different portions of an example computer architecture 300 that facilitates tracking communicable pathogen exposures within a healthcare facility. More specifically, FIG. 3A depicts sensor 312a (e.g., an RFID or ultrasound sensor) connected to facility master computer system 100. Location 304 can be a location in a healthcare facility, such, as for example, a hallway, a patient's room, a common meeting area, a cafeteria, etc. Pathogen tracking manager 231 tracks exposures to communicable pathogens within the health care facility.

Diagnosed patient 301 has been diagnosed with a communicable disease (e.g., a bacterial infection) that can potentially cause communicable pathogens to be transmitted to other individuals that come in contact with diagnosed patient. Diagnosed patient 301 wears bracelet 305 that includes a transmitter (e.g., RFID or ultrasound). The transmitter of bracelet 305 is configured to transmit a unique signature that can be detected at sensors within the healthcare facility, including in sensor 312a. Similarly staff member 302 wears badge 306 that also includes a transmitter (e.g., RFID or ultrasound). The transmitter of badge 306 is also configured to transmit a unique signature that can be detected at sensors within the healthcare facility, including in sensor 312a.

Facility master computer system 100 can include data (e.g., a mapping or table) that associates the unique transmission signature of bracelet 305 with diagnosed patient 301 and that associates the unique transmission signature of badge 306 with staff member 302. Thus, when unique transmission signature of bracelet 305 is detected at a sensor, facility master computer system 100 infers that diagnosed patient 301 is in relatively close physical proximity to the sensor. Similarly, when unique transmission signature of badge 306 is detected at a sensor, facility master computer system 100 infers that staff member 302 is in relatively close physical proximity to the sensor.

When the unique signatures of both bracelet 305 and badge 306 are detected at the same sensor, facility master computer system 100 can also infer that diagnosed patient 305 and staff member 302 are in relatively close physical proximity to each other. For example, sensor 312a may be capable of detecting transmissions within in proximity 303 Thus, when sensor 312a detects the unique signatures of both bracelet 305 and badge 306 within a short time period (or even simultaneously), facility master computer system 100 can infer that diagnosed patient 301 and staff member 302 are both within proximity 303 (e.g., in the same room, in the same stairwell, in the same hallway, etc).

Upon inferring common occupancy of proximity 303, pathogen tracking manager 231 can access profiles for each of diagnosed patient 301 and staff member 302 (e.g., from storage 103 or storage device 226). For example, pathogen tracking manager 231 can access profile 311 (for patient 301) and profile 312 (for staff member 302). Pathogen tracking manager 231 can check profile 311 and profile 312 to determine if diagnosed patient 301 and/or staff member 302 respectively are at risk for spreading a communicable pathogen.

An individual can be identified as being at risk for spreading a communicable pathogen under a variety of different circumstances. For example, an individual can be identified as being at risk for spreading a communicable pathogen when the individual is diagnosed with a communicable disease (e.g., that can be spread through physical contact and/or the air). An individual can also be identified as being at risk for spreading a communicable pathogen subsequent to coming within a specified physical proximity of another individual that has been diagnosed with a communicable disease. An individual can also be identified as being at risk for spreading a communicable pathogen subsequent to coming within a specified physical proximity of another individual that is at risk for spreading a communicable pathogen.

The profile for an individual at risk for spreading a communicable pathogens can include data that reflects the at risk status. Thus, an at risk individual is essentially digitally tagged as being at risk through data in the individuals' profile. Pathogen tracking manager 231 can use the digital tags to monitor, track, and update the potential spread of communicable pathogens within a healthcare facility.

Accordingly, upon receiving profile 311 (for patient 301), pathogen tracking module 231 can access data item 321. Data item 321 reflects that the infection risk of diagnosed patient 301 is high, indicative of a diagnosed communicable disease. Thus, data item 321 indicates that diagnosed patient 301 is at risk for spreading communicable pathogens.

Similarly, upon receiving profile 312 (for staff member 302) pathogen tracking module 231 can access data item 322. Data item 322 reflects that staff member 302 is not currently potentially infectious Thus, data item 322 indicates that staff member 302 was not at risk for spreading a communicable pathogen prior to contact with diagnosed patient 301. However, based upon the high infection risk of diagnosed patient 301, pathogen tracking manager 231 can change the status of staff member 312 to indicate that staff member 302 is potentially infectious. Essentially, pathogen tracking manager 231 infers that staff member 302 is at risk for at least becoming a carrier of communicable pathogens associated with diagnosed patient 301 's infection.

Subsequent to contact with diagnosed patient 301 staff member 302 can move to another location within the healthcare facility. For example, referring now to FIG. 3B, staff member 302 moves to location 334. Also, present at location 334 is individual 331 (e.g., another staff member, patient, or a visitor). Individual 331 wears badge 332 that also includes a transmitter (e.g., RFID or ultrasound). The transmitter of badge 332 is also configured to transmit a unique signature that can be detected at sensors within the healthcare facility, including in sensor 312b. Sensor 312b (e.g., an RFID or ultrasound sensor) is connected to facility master computer system 100.

Facility master computer system 100 can include data that associates the unique transmission signature of badge 332 with individual 331. Thus, when unique transmission signature of bracelet 332 is detected at a sensor, facility master computer system 100 infers that individual 331 is in relatively close physical proximity to the sensor. When the unique signatures of both badge 306 and badge 332 are detected at the same sensor, facility master computer system 100 can infer that staff member 302 and individual 331 are in relatively close physical proximity to each other. For example, sensor 312b may be capable of detecting transmissions within in proximity 333. Thus, when sensor 312b detects the unique signatures of both badge 306 and badge 322 within a short time period (or even simultaneously), facility master computer system 100 can infer that staff member 302 and individual 331 are both within proximity 333 (e.g., in the same room, in the same stairwell, in the same hallway, etc).

Upon inferring common occupancy of proximity 333, pathogen tracking manager 231 can access profiles for each of staff member 302 and individual 331 (e.g., from storage 103 or storage device 226). For example, pathogen tracking manager 231 can access profile 312 (for staff member 302) and profile 341 (for individual 331). Pathogen tracking manager 231 can check profile 312 and profile 341 to determine if staff member 302 and/or individual 331 respectively are at risk for spreading a communicable pathogen.

Accordingly, upon receiving profile 312 (for staff member 302), pathogen tracking module 231 can access data item 322. Data item 322 reflects that staff member 302 is currently potentially infectious Thus, data item 322 indicates that staff member 302 is at risk for spreading a communicable pathogen (as a result of the previous contact with diagnosed patient 301).

Similarly, upon receiving profile 341 (for individual 331) pathogen tracking module 231 can access data item 342. Data item 342 reflects that individual 331 is not currently potentially infectious Thus, data item 342 indicates that individual 331 was not at risk for spreading a communicable pathogen prior to contact with staff member 302. However, based on the potentially infectious status of staff member 302, pathogen tracking manager 231 can change the status of individual 331 to indicate that individual 331 is also potentially infectious. Essentially, pathogen tracking manager 231 infers that individual 331 is at risk for at least becoming a carrier of communicable pathogens associated with diagnosed patient 301's infection (as a result of staff member 302's previous contact).

Subsequent to contact between staff member 302 and individual 332, staff member 302 can move to another location within the healthcare facility to perform hygiene procedures. For example, referring now to FIG. 3C, staff member 302 moves to location 351 (e.g., a hygiene station). Present within location 351 are sensor 312c, disinfecting dispenser 352, and glove disposal bin 354. Disinfecting dispenser 352 includes activating sensor 353 configure to detect when disinfecting dispensing 352 is activated. Glove disposal bin 354 includes scale 354 that measures the total weight of any material contained in glove disposal bin 354. Sensor 312c, activation sensor 353, and scale 356 are each connected to facility master computer system 100.

When the unique signature of badge 306 is detected at sensor 312c, facility master computer system 100 infers that staff member 302 is occupying location 351. Upon entering location 351, staff member 302 can remove gloves 357 and place gloves 357 in glove disposal bin 354. Upon placement of gloves 357, scale 356 can detect a change in the weight of the contents of glove disposal bin 354. Scale 356 can indicate this change in weight to facility master computer system 100. Facility master computer system 100 can infer from the change in weight that staff member 302 has de-gloved.

After de-gloving, staff member 302 can activate disinfectant dispenser 352 to obtain disinfectant (e.g., soap). Activation sensor 353 can detect activation of disinfecting dispenser 352. Activation sensor 353 can indicate activation of disinfecting dispenser 352 to facility master computer system 100. Facility master computer system 100 can infer from the activation of disinfecting dispenser 352 that staff member 302 has initiated hand washing.

Facility master computer system 100 can also monitor the amount of time badge 306 is continuously detected at location 351 after activation of disinfecting dispenser 352. If badge 306 is continuously detected for a requisite amount of time, facility master computer system 100 can infer that staff member 302 has sufficiently washed their hands. On the other hand if badge 306 is not continuously detected for a requisite amount of time, facility master computer system 100 infers that staff member 302 has not sufficiently washed their hands

Upon staff member 302's entry into or occupancy of location 351, pathogen tracking manager 231 can access profile 312 (for staff member 302). Pathogen tracking manager 231 can check profile 312 to determine if staff member 302 is at risk for spreading a communicable pathogen. Accordingly, upon receiving profile 312 (for staff member 302), pathogen tracking module 231 can access data item 322. Data item 322 reflects that staff member 302 is currently potentially infectious

Thus, data item 322 indicates that staff member 302 is at risk for spreading a communicable pathogen (as a result of the previous contact with diagnosed patient 301). However, based upon an inference of performing sufficient hygiene procedures, pathogen tracking manager 231 can change the status of staff member 312 to indicate that staff member 302 is not potentially infectious. Essentially, pathogen tracking manager 231 infers that staff member 302 is no longer at risk for spreading a communicable pathogen due disposing of potentially contaminated items and sanitizing of potentially contaminated body parts.

B. Methods for Tracking Communicable Pathogens

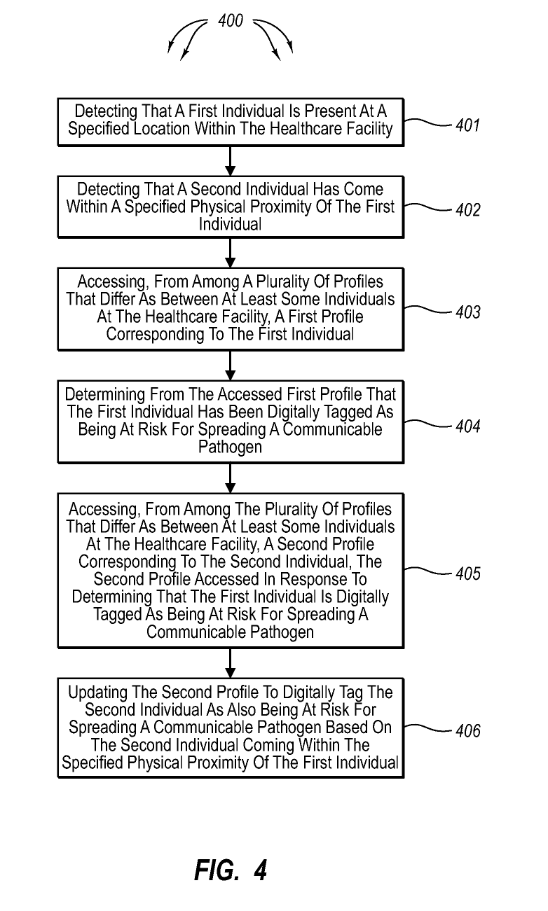

FIG. 4 is a flow chart that illustrates an exemplary method 400 for digitally tagging an individual as at risk for spreading a communicable pathogen. Method 400 will be described with respect to the components and data in architecture 300.

Method 400 includes an act of detecting that a first individual is present at a specified location within the healthcare facility (act 401). For example, referring to FIG. 3A, facility master computer system 100 can detect that diagnosed patient 301 is at location 304. Method 400 includes an act of detecting that a second individual has come within a specified physical proximity of the first individual (act 402). For example, referring to FIG. 3A, facility master computer system 100 can detect that staff member is at location 304.

Method 400 includes an act of accessing, from among a plurality of profiles that differ as between at least some individuals at the healthcare facility, a first profile corresponding to the first individual (act 403). For example, facility master computer system can access profile 311 for diagnosed patient 301. Method 400 includes an act of determining from the accessed first profile that the first individual has been digitally tagged as being at risk for spreading a communicable pathogen (act 404). For example, pathogen tracking manger 231 can determine from data item 321 that diagnosed patient 301 is at high risk for infection. It will be appreciated that acts 401-404 can be performed in any desired order (e.g., acts 403 and 404 can be performed before or simultaneous with acts 401 and 402).

Method 400 includes an act of accessing, from among the plurality of profiles that differ as between at least some individuals at the healthcare facility, a second profile corresponding to the second individual, the second profile accessed in response to determining that the first individual is digitally tagged as being at risk for spreading a communicable pathogen (act 405). For example, facility master computer system can access profile 312 for staff member 302. Profile 302 can be accessed in response to determining that diagnosed patient 301 has a high risk for infection. Method 400 includes an act of updating the second profile to digitally tag the second individual as also being at risk for spreading a communicable pathogen based on the second individual coming within the specified physical proximity of the first individual (act 406). For example, pathogen tracking manager 231 can update data item 322 to indicate that staff member 302 is potentially infectious. Data item 322 can be updated based on diagnosed patient 301 and staff member 302 commonly occupying proximity 303.

Method 400 can also be practiced in the environment depicted in FIG. 3B where individual 331 is digitally tagged as potentially infectious based on staff member 302 and individual 331 commonly occupying proximity 333.

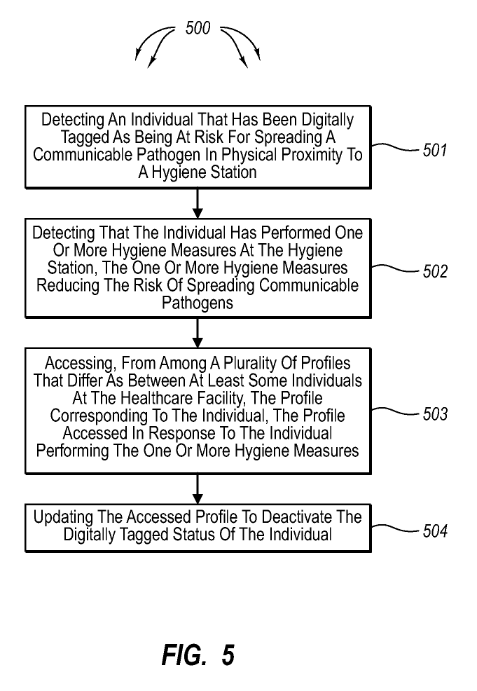

Turning now to FIG. 5, FIG. 5 is a flow chart that illustrates an exemplary method 500 for indicating that an individual has been disinfected. Method 500 will be described with respect to the components and data in architecture 300.

Method 500 includes an act of detecting an individual that has been digitally tagged as being at risk for spreading a communicable pathogen is in physical proximity to a hygiene station (act 501). For example, referring to FIG. 3C, facility master computer system 100 can detect that staff member 302 is at location 351.

Method 500 includes an act of detecting that the individual has performed one or more hygiene measures at the hygiene station, the one or more hygiene measures reducing the risk of spreading communicable pathogens (act 502). For example, facility master computer system 100 can detect that staff member 302 has de-gloved, applied disinfectant, and sufficiently washed hands.

Method 500 includes an act of accessing, from among a plurality of profiles that differ as between at least some individuals at the healthcare facility, the profile corresponding to the individual, the profile accessed in response to the individual performing the one or more hygiene measures (act 503). In response to detecting staff de-gloving, application of disinfectant and hand washing, facility master computer system 100 can access profile 312 for staff member 302. Pathogen tracking manger 231 can determine from data item 322 that, upon entering location 351, staff member 302 is potentially infectious.

Method 500 includes an act of updating the accessed profile to deactivate the digitally tagged status of the individual (act 504). For example, pathogen tracking manger 231 can update data item 322 to indicate that staff member 302 is not potentially infectious and is no longer a risk for spreading a communicable pathogen.

Accordingly, embodiments of the invention can be implemented to track the potential spread of communicable pathogens within a healthcare facility.

### IV. Profile Maintenance and Refinement

One aspect of the inventive monitoring systems and methods for assessing and ensuring quality and performance is the use and refinement of patient specific profiles. Individual profiles permit the inventive patient monitoring systems and methods to more accurately assess the quality of care and wellness of each patient, as among a plurality of patients having a variety of different attributes and needs. Patient profiles permit the inventive systems and methods to better interpret conditions and actions of and interactions between patients and staff that may lead to an actionable or triggering event. This reduces the incidence of false positives and false negatives and may reduce staff response times to critical clinical events.

A. Individual Profile

The type of data contained in an individual (e.g., patient, provider, visitor, etc.) profile can be selected, populated and modified as required depending on any desired care and wellness criteria and/or learned information. The following individual profile is merely one example of a suitable profile for use in collecting and processing data by the modules described above. It is given by way of example, not by limitation. Each line represents an independent inquiry that can be analyzed using one or more computer-monitored data channels. Data may be static or dynamic. Dynamic data can either by altered automatically or manually

S = Static Parameter
AD = Automatically Dynamic Parameter
MD = Manually Dynamic Parameter
Other parameters
.
.
.
C. Infection Risk Level - #, MD
D. Potentially Infectious - YES/NO, AD
.
.
.
Other parameters

Data items C and D are examples of data field types that can be maintained and tracked through use an individual profile. However, a wide range of other data filed types can also be maintained and tracked. The value of data item C can be adjusted upward when the risk that an individual (e.g., a patient) has a communicable pathogen (e.g., a contagious infection) increases. The value of data item C can be adjusted downward when the risk that an individual (e.g., a patient) has a communicable pathogen decreases. In some embodiments, an infection risk level ranges from 1-10. 1 indicates essentially no risk that an individual has a communicable pathogen. 10 indicates virtual certainty (e.g., a configured diagnosis) that an individual has a communicable pathogen. A healthcare provider can manually adjust an infection risk level based on changes in individual's condition, such as, for example, worsening signs and/or symptoms, results of laboratory testing, response to medication, etc.

The value of data item D can be updated to “YES” when an individual comes within a specified physical proximity of another individual that is at risk for spreading a communicable pathogen. An at risk individual can be a high risk infectious patient (e.g., a patient having a configured diagnosis) or another individual that is potentially infectious. The value of Item D can be update to “NO” in response to sensors detecting that an individual has performed proper hygiene to mitigate the risk for spreading a communicable pathogen. A facility master computer system can automatically adjust an indication of potential infectiousness.

B. Refinement of Profiles

Generally, patient profiles can be maintained and refined. A computer system stores an initial profile for each of a plurality of individuals at a facility based on at least one of specific personalized information for an individual or general information common to more than one individual. The computer system receives collected sensor data relating to each of the individuals at the facility. The computer system refines individual profiles based on collected sensor data in order to modify at least one of an alarm level, care or wellness parameter, or a treatment regimen for the patient. Individual profiles can be updated by way of an information feedback loop in which potentially actionable events are confirmed or denied through human intervention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a healthcare facility, a method for digitally transferring an indication that an individual is at risk for spreading a communicable pathogen, the method comprising:
detecting that a first individual is present at a specified location within the healthcare facility;
detecting that a second individual has come within a specified physical proximity of the first individual;
accessing, from among a plurality of profiles that differ as between at least some individuals at the healthcare facility, a first profile corresponding to the first individual;
determining from the accessed first profile that the first individual has been digitally tagged as being at risk for spreading a communicable pathogen;
accessing, from among the plurality of profiles that differ as between at least some individuals at the healthcare facility, a second profile corresponding to the second individual, the second profile accessed in response to determining that the first individual is digitally tagged as being at risk for spreading a communicable pathogen; and
updating the second profile to digitally tag the second individual as also being at risk for spreading a communicable pathogen based on the second individual coming within the specified physical proximity of the first individual.

2. The method as recited in claim 1, wherein:
detecting that a first individual is present at a specified location within the healthcare facility comprises detecting that a patient is present in a patient room at the healthcare facility; and
detecting that a second individual has come within a specified physical proximity of the first individual comprises detecting a healthcare facility worker is present in the patient room.

3. The method as recited in claim 1, wherein detecting that a first individual is present at a specified location within the healthcare facility comprises receiving communication from an RFID receiver.

4. The method as recited in claim 1, wherein detecting that a first individual is present at a specified location within the healthcare facility comprises receiving communication from an ultrasound receiver.

5. The method as recited in claim 1, wherein accessing, from among a plurality of profiles that differ as between at least some individuals at the healthcare facility, a first profile corresponding to the first individual comprises accessing a profile selected from among a patient profile, a staff member profile, and a visitor profile.

6. The method as recited in claim 1, wherein determining from the accessed first profile that the first individual has been digitally tagged as being at risk for spreading a communicable pathogen comprises determining from the first profile that the first individual has been diagnosed with a communicable disease.

7. The method as recited in claim 1, wherein determining from the accessed first profile that the first individual has been digitally tagged as being at risk for spreading a communicable pathogen comprises determining from the profile that the first individual previously came in contact with another individual that was digitally tagged as being at risk for spreading a communicable pathogen.

8. The method as recited in claim 1, wherein accessing, from among the plurality of profiles that differ as between at least some individuals at the healthcare facility, a second profile corresponding to the second individual comprises accessing a staff member profile in response to the staff member treating a patient, the patient's profile indicating that the patient was diagnosed with a communicable disease.

9. The method as recited in claim 1, wherein accessing, from among the plurality of profiles that differ as between at least some individuals at the healthcare facility, a second profile corresponding to the second individual comprises accessing a first staff member profile in response to a first staff member coming with a specified physical proximity of a second staff member, the second staff member's profile indicating that the second staff member is at risk for spread communicable pathogens.

10. The method as recited in claim 1, wherein updating the second profile to digitally tag the second individual as also being at risk for spreading a communicable pathogen comprises updating a profile selected from among a patient profile, a staff member profile, visitor profile based on corresponding patient, staff member, or visitor respectively coming within the specified physical proximity of the first individual.

11. The method as recited in claim 1, further comprising:
sending an electronic message to a staff member to alert the staff member that the second individual was digitally tagged as being at risk for spreading a communicable pathogen.

12. The method as recited in claim 11, wherein sending an electronic message to a staff member comprises sending an electronic message to a staff member to alert the staff member that the staff member has been digitally tagged as being at risk for spreading a communicable pathogen.

13. The method as recited in claim 1, further comprising subsequent to digitally tagging the second individual as being at risk for spreading a communicable pathogen:
detecting that the second individual has performed one or more hygiene measures at a hygiene station, the one or more hygiene measures reducing the risk of spreading communicable pathogens;
accessing, from among a plurality of profiles that differ as between at least some individuals at the healthcare facility, the second profile corresponding to the second individual, the second profile accessed in response to the second individual performing the one or more hygiene measures; and
updating the accessed second profile to deactivate the digitally tagged status of the second individual.

14. The method as recited in claim 13, wherein detecting that the second individual has performed one or more hygiene measures at a hygiene station comprises detecting that the second individual has de-gloved.

15. The method as recited in claim 13, wherein detecting that the second individual has performed one or more hygiene measures at a hygiene station comprises detecting that the second individual has activated a disinfectant dispenser.

16. The method as recited in claim 13, wherein detecting that the second individual has performed one or more hygiene measures at a hygiene station comprises detecting that the second individual has washed their hands for a requisite amount of time.

17. At a healthcare facility, a method for deactivating a digital indication that an individual is at risk for spreading a communicable pathogen, the method comprising:
detecting an individual that has been digitally tagged as being at risk for spreading a communicable pathogen in physical proximity to a hygiene station;
detecting that the individual has performed one or more hygiene measures at the hygiene station, the one or more hygiene measures reducing the risk of spreading communicable pathogens;
accessing, from among a plurality of profiles that differ as between at least some individuals at the healthcare facility, the profile corresponding to the individual, the profile accessed in response to the individual performing the one or more hygiene measures; and
updating the accessed profile to deactivate the digitally tagged status of the individual

18. The method as recited in claim 17, wherein detecting an individual that has been digitally tagged as being at risk for spreading a communicable pathogen in physical proximity to a hygiene station comprises detecting a staff member that recently treated a patient at the hygiene station, the patient diagnosed with a communicable disease.

19. The method as recited in claim 17, wherein detecting an individual that has been digitally tagged as being at risk for spreading a communicable pathogen in physical proximity to a hygiene station comprises receiving communication form an RFID receiver.

20. The method as recited in claim 17, wherein detecting an individual that has been digitally tagged as being at risk for spreading a communicable pathogen in physical proximity to a hygiene station comprises receiving communication from an ultrasound receiver.

21. The method as recited in claim 17, wherein detecting that the individual has performed one or more hygiene measures at a hygiene station comprises detecting that the individual has de-gloved.

22. The method as recited in claim 17, wherein detecting that the individual has performed one or more hygiene measures at a hygiene station comprises detecting that the individual has activated a disinfectant dispenser.

23. The method as recited in claim 17, wherein detecting that the individual has performed one or more hygiene measures at a hygiene station comprises detecting that the individual has washed their hands for a requisite amount of time.

24. A computer program product for use at a healthcare facility computer system, the computer program product for a method for digitally transferring an indication that an individual is at risk for spreading a communicable pathogen, the computer program product comprising one or more physical storage media having stored thereon computer-executable instructions that, when executed at a processor, cause the healthcare facility computer system to perform the method, comprising:
(a) detecting that a first individual is present at a specified location within the healthcare facility;
(b) detecting that a second individual has come within a specified physical proximity of the first individual;
(c) accessing, from among a plurality of profiles that differ as between at least some individuals at the healthcare facility, a first profile corresponding to the first individual;
(d) determining from the accessed first profile that the first individual has been digitally tagged as being at risk for spreading a communicable pathogen;
(e) accessing, from among the plurality of profiles that differ as between at least some individuals at the healthcare facility, a second profile corresponding to the second individual, the second profile accessed in response to determining that the first individual is digitally tagged as being at risk for spreading a communicable pathogen; and
(f) updating the second profile to digitally tag the second individual as also being at risk for spreading a communicable pathogen based on the second individual coming within the specified physical proximity of the first individual.

25. The computer program product as recited in claim 24, wherein the computer-executable instructions for performing (d), when executed at a processor, further cause the healthcare facility computer system to determine from the accessed first profile that the first individual has been diagnosed with a communicable disease.

26. The computer program product as recited in claim 24, wherein the computer-executable instructions for performing (d), when executed at a processor, further cause the healthcare facility computer system to determine from the first profile that the first individual previously came in contact with another individual that was digitally tagged as being at risk for spreading a communicable pathogen.

27. The computer program product as recited in claim 24, further comprising computer-executable instructions that, when executed at a processor, cause the healthcare facility computer system to:
detect that the second individual has performed one or more hygiene measures at a hygiene station, the one or more hygiene measures reducing the risk of spreading communicable pathogens;
access, from among a plurality of profiles that differ as between at least some individuals at the healthcare facility, the second profile corresponding to the second individual, the second profile accessed in response to the second individual performing the one or more hygiene measures; and
update the accessed second profile to deactivate the digitally tagged status of the second individual.

28. A computer program product for use at a healthcare facility computer system, the computer program product for implementing a method for deactivating a digital indication that an individual is at risk for spreading a communicable pathogen, the computer program product comprising one or more physical storage media having stored thereon computer-executable instructions that, when executed at a processor, cause the healthcare facility computer system to perform the method, comprising:
(a) detecting an individual that has been digitally tagged as being at risk for spreading a communicable pathogen in physical proximity to a hygiene station;
(b) detecting that the individual has performed one or more hygiene measures at the hygiene station, the one or more hygiene measures reducing the risk of spreading communicable pathogens;
(c) accessing, from among a plurality of profiles that differ as between at least some individuals at the healthcare facility, the profile corresponding to the individual, the profile accessed in response to the individual performing the one or more hygiene measures; and
(d) updating the accessed profile to deactivate the digitally tagged status of the individual

29. The computer program product as recited in claim 28, wherein the computer-executable instructions for performing (b), when executed at a processor, further cause the healthcare facility computer system to detect that the individual has de-gloved.

30. The computer program product as recited in claim 28, wherein the computer-executable instructions for performing (b), when executed at a processor, further cause the healthcare facility computer system to detect that the individual has activated a disinfectant dispenser.

31. The computer program product as recited in claim 28, wherein the computer-executable instructions for performing (b), when executed at a processor, further cause the healthcare facility computer system to detect that the individual has washed their hands for a requisite amount of time.
